(19) United States
(12) Patent Application Publication
(10) Pub. No.: US 2012/0043162 A1
(43) Pub. Date: Feb. 23, 2012

(54) TENDON CONTROLLED MOBILE PLATFORM

(75) Inventors: Sang-Whee Kim, Seongnam-si Gyeonggi-do (KR); Yun-Seo Choi, Seoul (KR); Jae-Hoon Kim, Daejeon (KR); Young-Jun Park, Daejeon (KR)

(73) Assignee: SAMSUNG HEAVY IND. CO., LTD., Seoul (KR)

(21) Appl. No.: 13/263,231

(22) PCT Filed: Apr. 1, 2010
(86) PCT No.: PCT/KR10/02018

§ 371 Date: Nov. 9, 2011

(30) Foreign Application Priority Data
Apr. 6, 2009 (KR) 10-2009-0029627

(51) Int. Cl. E04G 3/30; B66D 1/30

(52) U.S. Cl. 182/142

(57) ABSTRACT

The present invention discloses a tendon controlled mobile platform configured to move within a work space defined by a structure. The tendon controlled mobile platform of the present invention, which includes: a mobile platform including a main frame, a plurality of upper winches coupled to an upper part of the main frame, and a plurality of lower winches coupled to a lower part of the main framed, the mobile platform being placed with the work space; a plurality of first wires having respective one ends coupled to lower sides of the structure and respective the other ends coupled to the upper winches, the lengths of the first wires being adjustable; and a plurality of second wires having respective one ends coupled to upper sides of the structure and respective the other ends coupled to the lower winches, the lengths of the second wires being adjustable, can expand the movement range of the mobile platform, thereby expanding the work area, and can easily move the work equipment to an adjacent work area.

### TECHNICAL FIELD

The present invention relates to a tendon-controlled mobile platform, more specifically to a tendon-controlled mobile platform for moving work equipment within a work space defined by a structure such as partition walls of a ship block.

### BACKGROUND ART

The hull of a ship is generally produced by manufacturing units of blocks, which constitute portions of the ship, and then assembling the blocks. That is, after removing the rust or foreign substances from the surface of raw material by use of a method such as blasting and then painting the raw material for the prevention of corrosion, the raw material is made to blocks by, for example, welding, and these blocks are assembled together to complete the hull.

Welding, blasting and painting need to be also performed inside each block. Accordingly, various tasks, from collecting the grit used for the blasting to drying the film of paint after the painting to measuring the film of paint, are carried out inside the block. Accordingly, there have been ongoing efforts to develop various kinds of automation equipment for welding, painting, inspection, etc. in order to improve the work efficiency inside the block.

The inside of the block is surrounded by structures such as partition walls or shell plates and has a plurality of reinforcing materials, such as longi or stiffner, installed therein in order to reinforce the structural rigidity of the hull. The reinforcing materials are installed to protrude toward the inside of the block. Accordingly, the reinforcing materials interrupt various tasks described above inside the block.

Illustrated in FIG. 1 is an example of an inside of a block of a hull.

Referring to FIG. 1, an inside of block 10 has a plurality of reinforcing materials 15, 16 installed thereon to protrude inwardly. The inside of block 10 can be also partitioned into a plurality of work spaces 11 by a structure such as a partition wall 13. Formed in the partition wall 13 can be a manhole 17, which can be used as a path for a worker and through which the worker and work equipment can be moved.

Therefore, during the shipbuilding process, workers try to avoid the complex structures of the reinforcing materials 15, 16 located on the inside of block 10, manually move and install automation equipment every time the automation equipment is to be used. Moreover, in order to perform a task on an upper part of the inside of block 10, a scaffold (not shown) needs to be installed on the inside of block 10, and the worker needs to stand on the scaffold to perform such task.

As such, it requires much time, labor and costs to perform the task while the workers try to avoid the complex structures or install and move the scaffold (not shown) on the inside of block 10.

Particularly, in case automation equipment for welding, painting and inspection on the inside of block 10 is used, the structures such as the reinforcing materials 15, 16, and the scaffold (not shown) installed on the inside of block 10 lower the work efficiency of the automation equipment.

Moreover, due to various problems caused by sinking of single hull oil tankers, the International Marine Organization has required since 1996 that all oil tankers be built with a double-hull structure and all LNG carriers be built with a double-hull structure for the safety of the hull. Therefore, the inside of block of a ship has more complicated shapes, making it more difficult to perform the task inside the block.

Therefore, there has been a demand for the development of technology that can allow an easier performance of various tasks inside the work space that is defined by the complicated structure such as the inside of block of a ship.

### DISCLOSURE

### Technical Problem

Contrived to solve the above problem, the present invention allows work equipment to be readily moved in a work space inside a block without being interrupted by reinforcing materials, etc. that are installed inside the block and expands the work area.

### Technical Solution

Contrived to solve the above problem, an aspect of the present invention features a tendon controlled mobile platform configured to move within a work space defined by a structure, including: a mobile platform comprising a main frame, a plurality of upper winches coupled to an upper part of the main frame, and a plurality of lower winches coupled to a lower part of the main frame, the mobile platform being placed with the work space; a plurality of first wires having respective one ends coupled to lower sides of the structure and respective the other ends coupled to the upper winches, the lengths of the first wires being adjustable; and a plurality of second wires having respective one ends coupled to upper sides of the structure and respective the other ends coupled to the lower winches, the lengths of the second wires being adjustable.

The plurality of upper winches and the plurality of lower winches can be arranged at locations that are separated from one another, when viewed from a perpendicular direction of a plane that separates the upper part of the main frame from the lower part of the main frame. The tendon controlled mobile platform can include four upper winches and four lower winches, and the four upper winches and the four lower winches can be arranged to form respective rectangles on the plane that separates the upper part of the main frame from the lower part of the main frame, and any pair of facing sides of the rectangle formed by the four lower winches can be shorter than any pair of facing sides of the rectangle formed by the four upper winches.

The tendon controlled mobile platform can also include guide rails coupled to the main frame and configured to guide work equipment. The guide rails can include a plurality of guide bars that are parallel to one another, and the plurality of guide bars can be supported by a plurality of supporters protruded from the main frame. A cross-section of each of the plurality of guide bars can have the shape of a rectangle with one side open, and opened sides can face one another. Each of the plurality of guide bars can have a rack gear arranged or formed therein along a lengthwise direction, and the work equipment can include a plurality of pinion gears engaged with the plurality of rack gears. The work equipment can also include a plurality of rollers having linear contact with the guide rails.

### Advantageous Effects

The tendon controlled mobile platform in accordance with the present invention can easily move the mobile platform mounted with the work equipment to a desired location within the work space, allowing various tasks to be carried out efficiently without being hindered by obstacles such as reinforcing materials installed inside a block, and can fully automate the tasks, thereby saving the cost and time required for the tasks.

### DESCRIPTION OF DRAWINGS

FIG. 1 is a perspective view of an example of a work space inside a block of a ship.

FIG. 2 is a perspective view briefly showing a tendon controlled mobile platform in accordance with an embodiment of the present invention.

FIG. 3 is a perspective view showing a mobile platform of the tendon controlled mobile platform in accordance with an embodiment of the present invention.

FIG. 4 is a perspective view showing transporting of work equipment to an adjacent work space using the tendon controlled mobile platform in accordance with an embodiment of the present invention.

FIG. 5 is a side view briefly showing an example of comparison for describing a wire connection method of the tendon controlled mobile platform in accordance with an embodiment of the present invention.

FIG. 6 is a side view briefly showing the tendon controlled mobile platform in accordance with an embodiment of the present invention.

FIG. 7 is a front view of an example of work equipment mounted on the mobile platform shown in FIG. 3.

FIG. 8 is an enlarged view of the portion marked “A” in FIG. 7.

### MODE FOR INVENTION

Hereinafter, an embodiment of the present invention will be described in detail with reference to the accompanying drawings. Any identical or corresponding elements will be assigned with identical reference numerals, and they will not be described redundantly. Moreover, a block constituting the hull of a ship will be described as an example of a work space in which a tendon controlled mobile platform in accordance with the present invention is used.

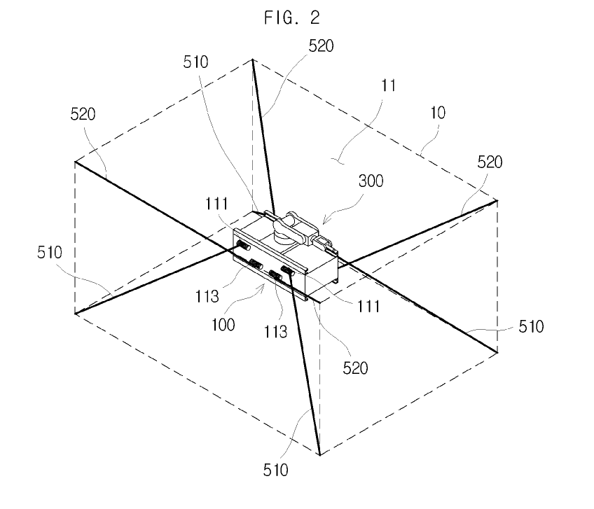

FIG. 2 shows work equipment mounted on a tendon controlled mobile platform in accordance with an embodiment of the present invention.

Referring to FIG. 2, the tendon controlled mobile platform in accordance with an embodiment of the present invention that includes a mobile platform 100, a first wire 510 and a second wire 520 is installed in a work space 11 on an inside of block 10, and work equipment 300 is mounted on the tendon controlled mobile platform 100.

Connected respectively to a plurality of upper winches 111 installed in the mobile platform 100 are the other ends of a plurality of the first wires 510, which are coupled to a lower side of a structure having one end thereof defining the work space. Moreover, connected respectively to a plurality of lower winches 113 are the other ends of a plurality of the second wires 520, which are coupled to an upper side of the structure.

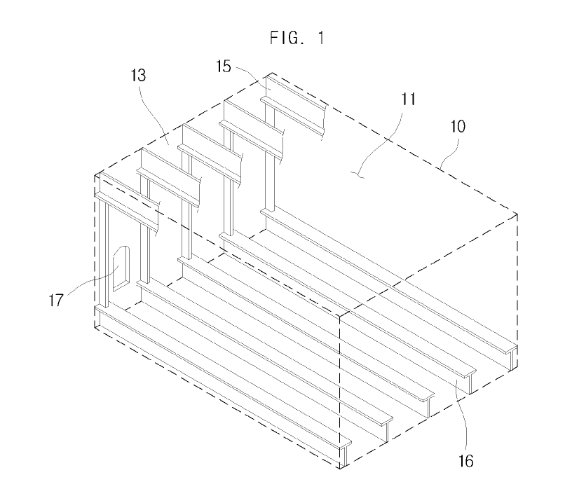

Here, the structure refers to, for example, a partition wall (see reference numeral 13 in FIG. 1) or a reinforcing material (see reference numerals 15 and 16 in FIG. 1), which is located in a boundary area of a work space (see reference numeral 11 of FIG. 1).

The plurality of upper winches 111 wind or unwind the plurality of first wires 510 to adjust the length of the first wires 510, and the plurality of lower winches 113 wind or unwind the plurality of second wires 520 to adjust the length of the second wires 520. By adjusting the lengths of the plurality of first wires 510 and the plurality of second wires 520, the location of the mobile platform 100 inside the work space 11 is changed. Therefore, by controlling the plurality of upper winches 111 and the plurality of lower winches 113, the mobile platform 100 can be moved to a desired location in the work space 11.

As the mobile platform 100 moves in a floated manner within the work space 11, movement of the mobile platform 100 is not interrupted by the reinforcing materials 15, 16. Particularly, since the mobile platform 100 can be moved to a target location in a shortest route, the time required for moving can be minimized

The work equipment 300 can be equipment that performs various required tasks, for example, welding, blasting, painting and surface inspection, within the work space 11. Therefore, the tendon controlled mobile platform in accordance with an embodiment of the present invention can move the work equipment 300 quickly and easily to a location at which the task needs to be carried out in the work space 11.

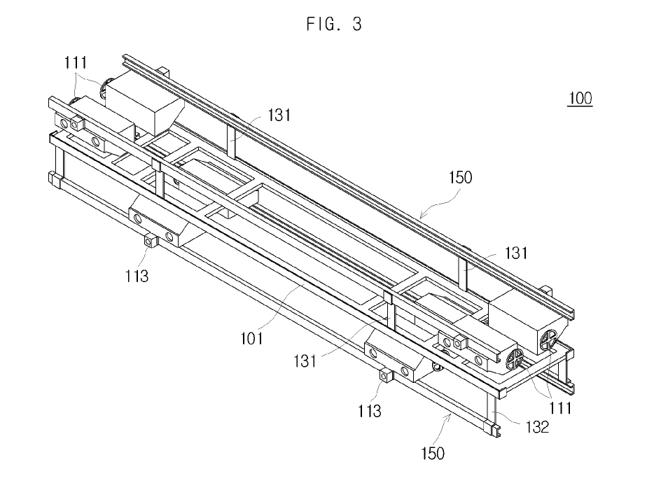

The mobile platform 100 will be described in more detain later with reference to FIG. 3.

FIG. 3 illustrates a mobile platform of the tendon controlled mobile platform in accordance with an embodiment of the present invention.

Referring to FIG. 3, the mobile platform 100 of the tendon controlled mobile platform in accordance with an embodiment of the present invention includes a main frame 101, the plurality of upper winches 111 and the plurality of lower winches 113.

The plurality of upper winches 111 are coupled to an upper part of the main frame 101, and the plurality of lower winches 113 are coupled to a lower part of the main frame 101. The upper winches 111 and the lower winches 113 are arranged in boundary areas of the main frame 101.

Supposing that there is a plane that divides the main frame 101 into the upper part and the lower part, and viewing the mobile platform 100 from a direction that is perpendicular to the plane, the upper winches 111 and the lower winches 113 are arranged to form apexes of respective rectangles. Here, the rectangle formed by the lower winches 113 has a shorter pair of sides that the rectangle formed by the upper winches 111.

In other words, the lower winches 113 are arranged to be closer toward the center of the main frame 101 than the upper winches 111. This will be described later in more detail with reference to FIGS. 5 and 6.

The mobile platform 100 also includes guide rails 150, which support and guide work equipment (see reference numeral 300 in FIG. 2) mounted in the mobile platform 100. Here, the guide rails 150 are supported to the main frame 101 by a plurality of supporters 131 that are formed or installed to protrude from the main frame 101.

The guide rails 150 can be installed on both an upper side and a lower side of the main frame 101, as illustrated, so that the work equipment (see reference numeral 300 of FIG. 2) can be mounted on both an upper side and a lower side of the mobile platform 100. Moreover, although not illustrated, the guide rails 150 can be installed on lateral sides of the main frame 101.

Here, the guide rails 150 are arranged to be parallel to one another. In the present invention, the term “parallel” refers to the state of being parallel considering errors occurred in the processing and installation, for example, a state of practically being parallel, like a pair of rails that are installed in the railroad.

Accordingly, the work equipment 300 can be mounted on the mobile platform 100 by these guide rails 150, and can be supported and guided by the guide rails 150 to move along a lengthwise direction of the guide rails 150.

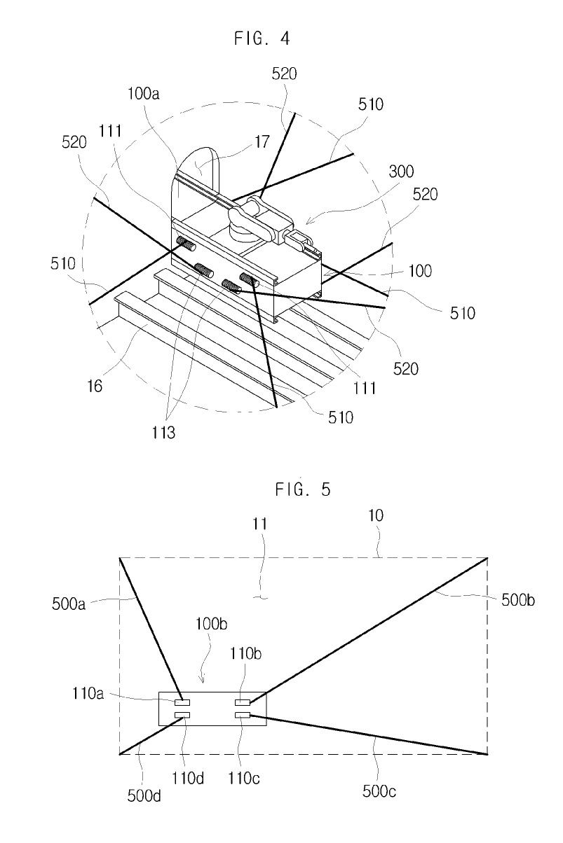

After completing the task in the work space 11 of the inside of block 10 using the work equipment 300, the work equipment 300 needs to be moved to another work space (not shown). The moving of the work equipment 300 will be described with reference to FIG. 4.

Illustrated in FIG. 4 is a perspective view of moving the work equipment to an adjacent work space using the tendon controlled mobile platform in accordance with an embodiment of the present invention. This will be described with reference to FIG. 1 as well.

Referring to FIG. 4, the work equipment 300 mounted on the mobile platform 100 of the tendon controlled mobile platform in accordance with an embodiment of the present invention can be moved to a mobile platform 100a installed in another, adjacent work space (not shown) through a manhole 17. In other words, after the task to be carried out within the work space 11 of the inside of block 10 is completed, the work equipment 300 can be moved to another work space to continue the task.

Therefore, one end of the mobile platform 100 should be able to make contact with another mobile platform 100a placed in another, adjacent block (not shown) through the manhole 17, and the work equipment 300 should be able to move from the mobile platform 100 to the other mobile platform 100a. For this, one end of the mobile platform 100 should be able to dock with the other mobile platform 100a, and thus the mobile platform 100 should be able to move to the manhole 17 and the other mobile platform 100a should be also able to move to the manhole 17. Moving the mobile platform 100 to the boundary of the work space 11 will be described later in more detail with reference to FIGS. 5 and 6.

FIG. 5 shows an example of comparison for describing a wire connection method of the tendon controlled mobile platform in accordance with an embodiment of the present invention, and FIG. 6 is a side view briefly showing the tendon controlled mobile platform in accordance with an embodiment of the present invention.

Referring to FIG. 5, the other ends of wires 500a, 500b, of which one ends thereof are coupled to a structure defining the work space 11 of the inside of block 10, are respectively connected to a plurality of winches 110a, 110b installed in a mobile platform 100b.

Here, the plurality of wires 500a, 500b are respectively connected to the winches 110a, 110b that are closest to the other ends of the wires 500a, 500b, which are coupled to the structure.

That is, as illustrated, the other end of the wire 500a having one end thereof coupled to an upper side of one side of the structure is connected to the winch 110a installed in an upper part of one side of the mobile platform 100b, and the other end of the wire 500b having one end thereof coupled to an upper side of the other side of the structure is connected to the winch 110b installed in an upper part of the other side of the mobile platform 100b. Remaining wires 500c, 500d are also connected to adjacent winches 110c, 110d, respectively.

In this example of comparison having this kind of connection structure, the lengths of the wires 500a, 500d connected to a side of the structure to which the mobile platform 100b needs to be approached need to be maximally reduced, in case the mobile platform 100b is moved to one side of the work space 11, especially if the mobile platform 100b needs to be moved to a boundary of one side of the work space 11, as illustrated in FIG. 4.

A load applied to the mobile platform 100b is delivered to the wires 500a, 500b connected to the upper side of the structure, and the wires 500a, 500d that become shortened in order to move the mobile platform 100b become to have a greater tension. Therefore, in the illustrated case, the wire 500a coupled to the upper side of one side of the structure has the maximum tension.

Here, the closer the mobile platform 100b moves toward one side of the structure, the greater tension the wire 500a has. Also, in order to maintain the mobile platform in level, the wire 500b coupled to the upper side of the other side of the structure also becomes to have certain tension. Therefore, no matter how much tension the wire 500a has, a horizontal component force is applied to the mobile platform 100b by the wire 500b, making it difficult for the mobile platform 100b to reach the manhole 17 located at the boundary of the work space 11.

In order to solve the above problem, it is possible to cross the wires, and this will be described with reference to FIG. 6.

Referring to FIG. 6, the first wire 510 and the second wire 520 are respectively connected to the upper winch 111 and the lower winch 113 in a crossing manner.

Specifically, the other end of a second wire 520a coupled to the upper side of one side of the structure defining the work space 11 of the inside of block 10 and the other end of a first wire 510a coupled to the lower side of one side of the structure are respectively connected a lower winch 113a and an upper winch 111a installed on one side of the mobile platform 100. Likewise, the other end of a second wire 520b coupled to the upper side of the other side of the structure and the other end of a first wire 510b coupled to the lower side of the other side of the structure are respectively connected to a lower winch 113b and an upper winch 111b installed on the other side of the mobile platform 100.

Here, as illustrated, in case the mobile platform 100 is moved to the boundary of one side of the work space 11, the lengths of the first wire 510a on one side and the second wire 520a on one side are maximally reduced.

Here, in order to maintain the mobile platform 100 in level, the second wire 520b on the other side is tightened to keep the other side of the mobile platform 100 from moving downward. However, if tension is given to the second wire 520b on the other side, horizontal force toward the boundary on the other side of the work space 11 is exerted to the mobile platform 100, inhibiting the mobile platform 100 from moving to the boundary on one side of the work space 11.

Here, if tension is given to the first wire 510a on one side, horizontal force moving the mobile platform 100 toward the boundary on one side of the work space 11 and vertical force moving one side of the mobile platform 100 downward are exerted to the mobile platform 100.

The vertical force moving one side of the mobile platform 100 downward works as moment about the lower winch 113a installed on one side because the lower winch 113a installed on one side is supported by the second wire 520a on one side not move downward, thereby working as a force lifting the other side of the mobile platform 100.

Therefore, the tension given to the second wire 520b on the other side can be reduced, and thus the horizontal force exerted to the mobile platform 100 toward the other side of the work space 11 by the second wire 520b on the other side can be reduced. Moreover, the mobile platform 100 can be easily moved toward one side of the work space 11 by the horizontal force exerted to the mobile platform 100 toward one side of the work space 11 by the first wire 510a on one side.

Meanwhile, horizontal force toward one side of the work space 11 is also exerted to the mobile platform 100 by the second wire 520a on one side, thereby allowing the mobile platform 100 to move to the boundary on one side of the work space 11.

Accordingly, as the tension for keeping the mobile platform 100 in level is dispersed to the first wire 510a on one side and the second wire 520b on the other side, the moving range of the mobile platform 100 can be increased.

As described above, moving the mobile platform 100 to the boundary on one side of the work space 11 requires use of the moment applied to the mobile platform 100 about the lower winch 113a on one side by the first wire 510a on one side. In order to utilize such moment, the upper winches 111 and the lower winches 113 need to be spaced from one another when viewed from a perpendicular direction of the plane that separates the upper part and lower part of the main frame (reference numeral 101 of FIG. 3) of the mobile platform 100, as described with reference to FIG. 3.

Here, the optimal distance by which the upper winches 111 and the lower winches 113 are separated when viewed from the perpendicular direction of the plane separating the upper part of the main frame from the lower part can be obtained through experiments or simulation. Although not illustrated, in case the shape of a mobile platform is different from that of the illustrated mobile platform 100, the optimal distance by which the upper winches 111 and the lower winches 113 are separated also changes, and thus the separated distance can be changed according to the shape of the mobile platform.

For reference, as illustrated, in case the mobile platform 100 is moved to the boundary on one side of the work space 11, the second wire 520a on one side becomes to have maximum tension, and thus it is required to use the second wire 520a that has a greater allowable tensile strength than the maximum tension.

As described above, the moving range of the mobile platform 100 can be expanded by arranging the upper winches 111 and the lower winches 113 at separated locations when viewed from the perpendicular direction of the plane separating the upper part of the main frame (reference numeral 101 of FIG. 3) of the mobile platform 100 from the lower part thereof. Also, as described with reference to FIG. 4, the work equipment 300 can be easily moved to the adjacent mobile platform 100a, thereby completely automating the tasks carried out by the work equipment 300.

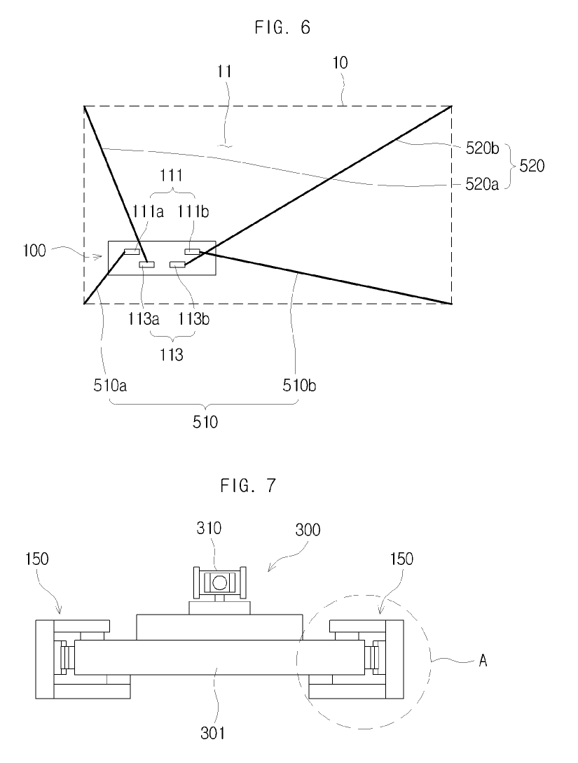

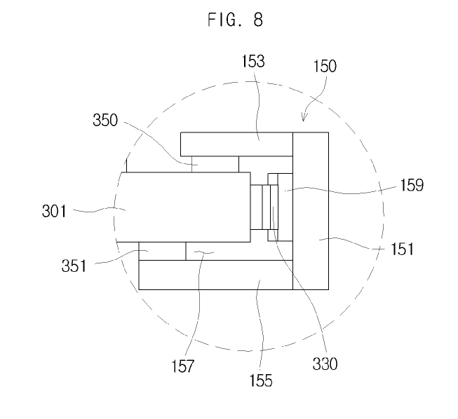

FIG. 7 is a front view of an example of work equipment mounted on the mobile platform shown in FIG. 3, and FIG. 8 is an enlarged view of the portion marked “A” in FIG. 7.

Referring to FIG. 7, the work equipment 300 is supported and guided by the pair of guide rails 150. Here, as illustrated, the work equipment 300 can include a base 301, which is moveably coupled to the guide rails 150, and a work robot 310, which performs the various tasks described above.

Referring to FIG. 8, the guide rail 150 includes a guide bar 151, and the guide bar 151 has a plurality of flanges 153, 155, which support and guide the base 301 in vertical directions, installed or integrated therein. Accordingly, the lengthwise cross-section of the guide rails 150 has the shape of a rectangle with one side open, and opened sides 157 are arranged to face each other to support and guide both ends of the base 301.

As described above, the base 301 can be moved along the lengthwise direction of the guide rails 150, and thus there can be friction between the base 301 and the flanges 153, 155. Moreover, vibrations generated while the work equipment 300 carries out the various tasks can be transferred to the guide rails 150 and cause a noise.

Therefore, a plurality of rollers 350, 351 are installed on upper and lower sides of the both ends of the base 301 to allow the rollers 350, 351 to have linear contact with the flanges 153, 155 and support the base 301 so that friction is kept from occurring between the upper and lower sides of the base 301 and the flanges 153, 155 or the vibrations are kept from transferring to one another.

To allow the work equipment 300 to move along the lengthwise direction of the guide rails 150, a rack gear 159 can be installed or formed to protrude along a lengthwise direction of the guide bar 151, and a pinion gear 330 can be installed in the base 301 to be engaged with the rack gear 159 and rotated by a driving device (not shown).

Although not illustrated, sprocket wheels can be installed on ether end of the guide rails 150. Then, by connecting the two sprocket wheels with a chain and coupling a portion of the chain to a portion on either end of the base 301, the work equipment 300 can be moved along the lengthwise direction of the guide rails 150.

Moreover, although not illustrated, by installing a screw axis along the lengthwise direction of the guide rails 150 and forming a nut part that is penetrated by the screw axis on both ends of the base 301, or by coupling a nut that is coupled with the screw axis to the base 301, the work equipment 300 can be moved along the lengthwise direction of the guide rails 150.

There can be other various linear movement apparatuses that can move the work equipment 300 along the lengthwise direction of the guide rails 150.

Meanwhile, when blasting or painting is performed using the work equipment 300, it is possible that dust or grit is brought in through the opened sides 157 of the guide rails 150. Therefore, although not illustrated, the opened sides 157 of the guide rails 150 can have a curtain-shaped dust-guard film or a dust-guard brush installed therein.

Although a tendon controlled mobile platform in accordance with an embodiment of the present invention has been described, the technical ideas of the present invention are not restricted to the embodiment presented herein, and another embodiment shall be possible by a person of ordinary skill in the art to which the present invention pertains by supplementing, modifying, deleting and adding elements of the present invention within the same scope of the technical ideas, but this shall be also included in the scope of the technical ideas of the present invention.

1. A tendon controlled mobile platform configured to move within a work space defined by a structure, comprising:
a mobile platform comprising a main frame, a plurality of upper winches coupled to an upper part of the main frame, and a plurality of lower winches coupled to a lower part of the main frame, the mobile platform being placed with the work space;
a plurality of first wires having respective one ends coupled to lower sides of the structure and respective the other ends coupled to the upper winches, the lengths of the first wires being adjustable; and
a plurality of second wires having respective one ends coupled to upper sides of the structure and respective the other ends coupled to the lower winches, the lengths of the second wires being adjustable.

2. The tendon controlled mobile platform of claim 1, wherein the plurality of upper winches and the plurality of lower winches are arranged at locations that are separated from one another, when viewed from a perpendicular direction of a plane that separates the upper part of the main frame from the lower part of the main frame.

3. The tendon controlled mobile platform of claim 2, comprising four upper winches and four lower winches, and
wherein the four upper winches and the four lower winches are arranged to form respective rectangles on the plane that separates the upper part of the main frame from the lower part of the main frame, and
wherein any pair of facing sides of the rectangle formed by the four lower winches are shorter than any pair of facing sides of the rectangle formed by the four upper winches.

4. The tendon controlled mobile platform of claim 1, further comprising guide rails coupled to the main frame and configured to guide work equipment.

5. The tendon controlled mobile platform of claim 4, wherein the guide rails comprise a plurality of guide bars that are parallel to one another, and
wherein the plurality of guide bars are supported by a plurality of supporters protruded from the main frame.

6. The tendon controlled mobile platform of claim 5, wherein a cross-section of each of the plurality of guide bars has the shape of a rectangle with one side open, and opened sides face one another.

7. The tendon controlled mobile platform of claim 4, wherein each of the plurality of guide bars has a rack gear arranged or formed therein along a lengthwise direction, and
wherein the work equipment comprises a plurality of pinion gears engaged with the plurality of rack gears.

8. The tendon controlled mobile platform of claim 7, the work equipment further comprises a plurality of rollers having linear contact with the guide rails.
